(19) United States
(12) Patent Application Publication
(10) Pub. No.: US 2006/0028351 A1
(43) Pub. Date: Feb. 9, 2006

(54) Docking monitor

(76) Inventor: James M. Lewis, Moulton, AL (US)

Correspondence Address: WELSH & FLAXMAN LLC, 2000 DUKE STREET, SUITE 100, ALEXANDRIA, VA, 22314, US

(21) Appl. No.: 10/913,405

(22) Filed: Aug. 9, 2004

(51) Int. Cl. G08B 21/00

(52) U.S. Cl. 340/686.6

(57) ABSTRACT

A distance monitor for a loading dock includes a sensor monitoring the distance between itself and a vehicle approaching the sensor to generate an analog distance signal representative of the measured distance. The sensor further includes an analog to digital converter that produces a digital distance signal which is transmitted for further processing. The distance monitor also includes a control logic unit coupled to the sensor. The control logic unit includes an input for receiving the digital distance signal, a logic system for converting the digital distance signal for presentation and a display for viewing the distance information.

### BACKGROUND OF THE INVENTION

1. Field of the Invention

The invention relates to a loading dock monitor. More particularly, the invention relates to a loading dock monitor providing drivers with a numeric warning as a vehicle approaches a loading dock. The numeric warning provides drivers with the exact (or quantitative) distance from the vehicle to the dock.

2. Description of the Prior Art

The movement of freight in and out of warehouses can be a highly complicated endeavor. Particularly, with the many individuals working around loading docks and the many vehicles moving into and out of loading docks, the efficient movement of materials to and from warehouses can greatly benefit a company. As such, it is desirable to provide a mechanism for expediting and enhancing the movement of vehicles into and out of loading docks so the material upon the vehicles can be loaded/unloaded in an efficient, safe and reliable manner.

One of the major problems in moving vehicles into and out of loading docks relates to the size of the vehicles, which must be moved within close proximity of the loading dock. The vast size of these vehicles often makes it difficult for a driver to position the rear end of the vehicle adjacent the loading dock without damaging the loading dock or the vehicle itself. As such, a need currently exists for a mechanism which will provide a vehicle driver with useful information allowing him or her to easily move a vehicle into close proximity with a loading dock. The present invention provides a distance monitoring system offering loading dock owners and drivers a system for improving the movement of vehicles to and from loading docks.

### SUMMARY OF THE INVENTION

It is therefore, an object of the present invention to provide a distance monitor for a loading docking. The distance monitor includes a sensor monitoring the distance between itself and a vehicle approaching the sensor to generate an analog distance signal representative of the measured distance. The sensor further includes an analog to digital converter that produces a digital distance signal which is transmitted for further processing. The distance monitor also includes a control logic unit coupled to the sensor. The control logic unit includes an input for receiving the digital distance signal, a logic system for converting the digital distance signal for presentation and a display for viewing the distance information.

It is also an object of the present invention to provide a distance monitor wherein the sensor includes a microprocessor and the analog to digital converter forms a part of the microprocessor.

It is another object of the present invention to provide a distance monitor wherein the sensor is an IR sensor.

It is a further object of the present invention to provide a distance monitor wherein the sensor includes power input which is connected to the display for receiving power therefrom.

It is also another object of the present invention to provide a distance monitor wherein the logic system of the control logic unit includes means for converting the digital distance signal into distance information.

It is still another object of the present invention to provide a distance monitor wherein the logic system of the control logic unit includes adjustment means for calibration of the digital distance signal to suit specific mounting conditions for the sensor.

It is yet a further object of the present invention to provide a distance monitor wherein the control logic unit includes means for entering and exiting a sleep mode when necessitated by vehicle proximity to the loading dock.

It is also an object of the present invention to provide a distance monitor wherein the logic system is a programmable logic device.

It is another object of the present invention to provide a distance monitor including a secondary sensor.

It is a further object of the present invention to provide a distance monitor wherein the display presents information in reverse.

It is also an object of the present invention to provide a loading dock with the distance monitor described above.

Other objects and advantages of the present invention will become apparent from the following detailed description when viewed in conjunction with the accompanying drawings, which set forth certain embodiments of the invention.

### BRIEF DESCRIPTION OF DRAWINGS

FIGS. 1, 2 and 3 show various block diagrams in accordance with a preferred embodiment of the present invention.

FIG. 4 shows a block diagram in accordance with an alternate embodiment of the present invention.

FIGS. 5a and 5b respectively show the display with mirrored characters and normal characters.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

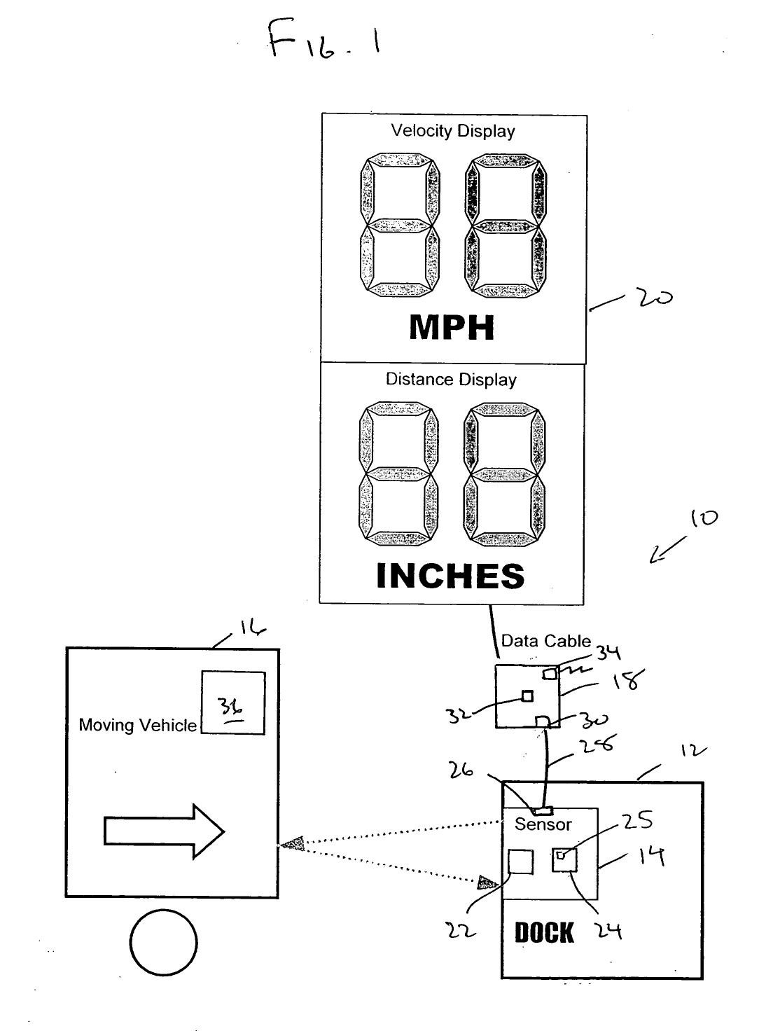

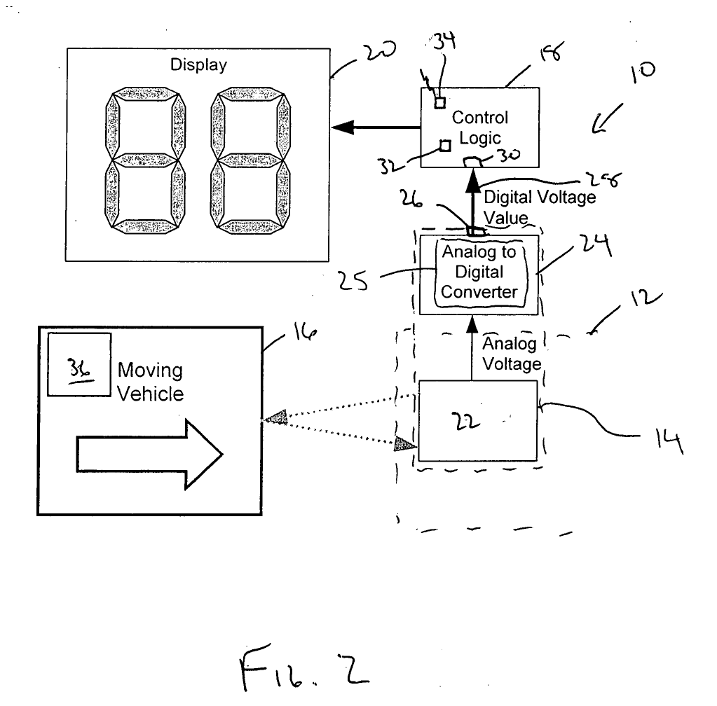

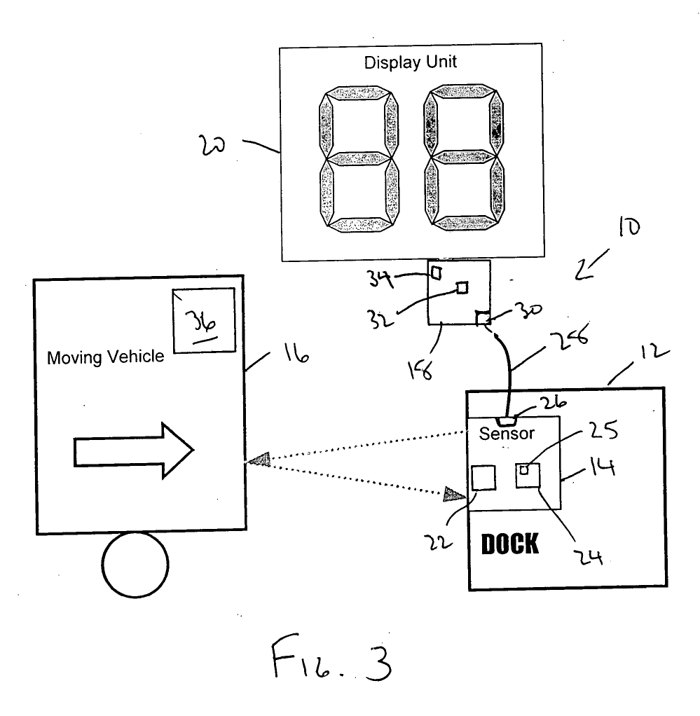

With reference to FIGS. 1, 2 and 3, a distance monitor 10 for a loading dock 12 is disclosed. The distance monitor 10 includes a sensor 14 monitoring the distance between itself and a vehicle 16 approaching the sensor 14. The distance monitor also includes a control logic unit 18 coupled to the sensor 14 for processing of the sensor generated distance information and displaying the relevant distance information.

Although the present distance monitor is described with reference to its use in a loading dock environment with vehicles approaching the dock, it is contemplated the present distance monitor may be used in a variety of environments, for example, but not limited to, ship and boat docking, train docking and aircraft docking, without departing from the spirit of the present invention.

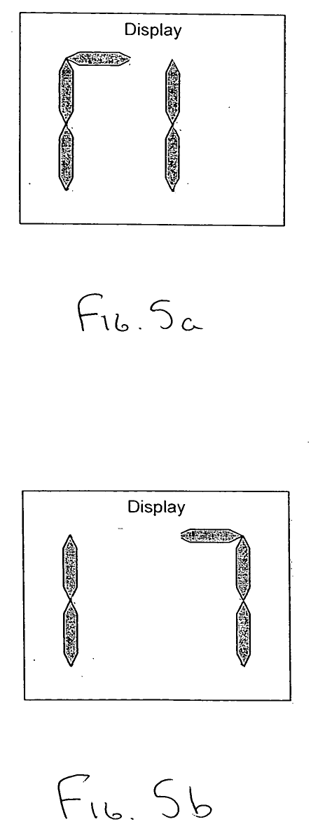

The present distance monitor 10 is a device for providing information to a truck driver or equipment operator about the distance from his vehicle 16 to a loading dock 12 or to some other important point. A display 20 presents the exact distance to the dock 12. As a vehicle is approaching a dock 12, the display 20 indicates the distance (the preferred embodiment displays the distance in inches) to the docking point. As will be discussed below in greater detail, a variety of display and sensor options are possible within the spirit of the invention. For example, the display 20 may selectively show the distance in mirrored characters (see FIG. 5a) so that a driver can read the information in the vehicle's rear-view mirror. Switching between mirrored (or reversed) characters and normal characters is achieved via a switch associated with the control logic unit 18.

The sensor is composed of an IR sensor unit 22, which works in a relatively traditional manner to convert distance information generated based upon reflected infrared signals to a voltage, or analog distance, signal representative of the measured distance. The sensor 14 further includes an integrated circuit 24 having an analog to digital converter 25 for converting the analog distance signal generated by the sensor 14 to a digital distance signal which is subsequently transmitted for further processing in a manner discussed below in greater detail. In accordance with a preferred embodiment of the present invention, the integrated circuit 24 is an analog to digital converter (part number MAX157B) from Maxim Semiconductor. This integrated circuit 24 converts the analog signal into a serial digital signal that is transmitted to the control logic unit 18 via a Cat5 cable 28. Although an integrated circuit with an analog to digital converter is disclosed in accordance with a preferred embodiment of the present invention, this process may be accomplished using a microprocessor that has an integrated analog to digital converter, or other equivalent device, without departing from the spirit of the present invention. In fact, use of a microprocessor would allow for added functionalities and, therefore, might be included with more robust versions of the present distance monitor.

In particular, and in accordance with a preferred embodiment of the present invention, the sensor 14 is a general purpose distance measuring optical sensor from Sharp Electronics (for example, the GP2Y0A21YJK and the GP2Y0A02YK). However, those skilled in the art will appreciate that any sensor that provides a reliable representation of distance may be used without departing from the spirit of the present invention. It is contemplated other optical sensors could be used (whether analog or digital output), or an ultrasound or other type of sensor could be used, without departing from the spirit of the present invention.

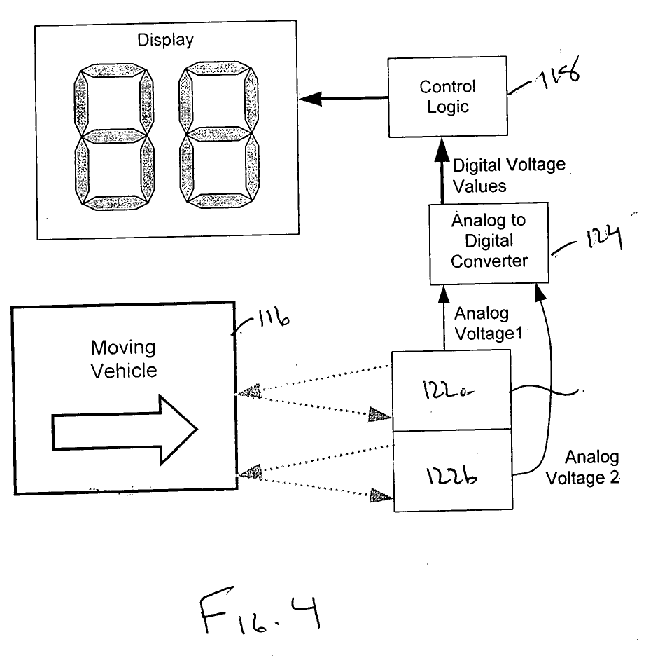

In accordance with a preferred embodiment, and with reference to FIG. 4, a pair of sensors 122a, 122b are employed; that is, two sensors, one GP2Y0A21YK and one GP2Y0A02YK. Because the sensor units 122a, 122b have different response curves, a more accurate representation of exact distance is possible as the vehicle 116 gets close to the docking point. The responses from the two sensors 122a, 122b are converted by the analog to digital converter 125 and are compared by the control logic unit 118 to provide a more accurate reading at short distances.

It is further contemplated the distance monitor may be designed to accept inputs from multiple identical sensors and multiple sensor pairs. Such alternate distance monitors would then display the shortest distance between any sensor and the moving object. This type of system would be useful when surfaces on the vehicle are irregular.

In addition to the IR sensor unit 22 and the analog to digital converter 25 of the integrated circuit 24, the sensor 14 includes a voltage regulator (not shown), a driver/receiver 26 for the transmission and receipt of information between the control logic unit 18 and the sensor 14, and a connector (not shown) shaped and dimensioned for coupling with a cable 28 lining the sensor 14 to the control logic unit 18. As those skilled in the art will certainly appreciate, the sensor may be provided with additional components useful in obtaining and conditioning a signal for providing vehicle operators with information concerning the distance between themselves and a loading dock.

In summary, the sensor 14 is held in position relative to a loading dock 12 such that the sensor unit 22 is aimed toward a target vehicle 16 for reflection off a nice flat surface of the approaching vehicle 16, or other object. As the vehicle 16 approaches the loading dock 12, the sensor 14 picks up on the approaching vehicle 16 and begins generating an analog distance signal that is converted to a digital distance signal by the analog to digital converter 25. The digital distance signal is serially transmitted to the control logic unit 18 using the driver/receiver 26 and the cable 28.

As mentioned above, the present loading dock distance monitor 10 also includes a control logic unit 18 coupled to the sensor 14. The control logic unit 18 includes a connector (not shown) shaped and dimensioned for connection with the cable 28 connecting the control logic unit 18 to the sensor 14. In accordance with a preferred embodiment, the control logic unit 18 is connected to the sensor 14 via the cable 28, which, in addition to transmitting digital distance signals from the sensor 14, provides power to the sensor 14 from the control logic unit 18. As such, the control logic unit 18 is coupled to a power supply adapted for powering both the sensor 14 and control logic unit 18. In accordance with a preferred embodiment of the present invention, a Cat5 cable is employed, although those skilled in the art will appreciate that other cabling structures may be employed without departing from the spirit of the present invention.

The control logic unit 18 further includes a driver/receiver 30 for receiving and transmitting information between the sensor 14 and the control logic unit 18, a logic system 32, for example, a programlable logic device (PLD), programmed for performing various calculations discussed below and a display 20 driven by a series of transistors. Although a PLD is disclosed in accordance with a preferred embodiment, the control logic unit may employ a microprocessor, programmable logic, or any logic system suitable for converting the digital distance signal into distance values and to also drive the display. In accordance with a preferred embodiment, the control logic unit 18 employs an Altera Programmable Logic Device with MOSFET drivers to interface between the PLD and the seven segment display (since the PLD operates on 1.5 vol and 3.3. volt power and the display requires 12 volt signals to illuminate the LED segments). The control logic unit 18 is designed to utilize a simple look-up table to convert from the digital distance signal to the distance values presented upon the display 20. A conversion equation or other conversion algorithm would basically perform the same task and is essentially the same concept.

Once the digital distance signal is received from the sensor 14, the logic system 32 of the control logic unit 18 converts the digital distance signal into distance (inches or centimeters) for presentation upon the display 20 of the control logic unit 18. In addition to converting the digital distance signal to a specific distance, the logic system 32 further converts the digital distance signal to a velocity which may also be presented upon the digital display 20. As those skilled in the art will certainly appreciate, the velocity calculation is based on distance per time interval, which is converted to miles per hour, or any other velocity units. The conversion is accomplished by measuring the time between distance increments.

The display 20 can be a seven segment LED display, an LCD display, a CRT monitor, a composite system or any suitable device that is electronically controllable to display the text-based information. In accordance with one preferred embodiment, the display 20 employs large (8 inch tall) seven segment LED displays. These displays are relatively inexpensive, rugged, and work well in a wide variety of environmental conditions. The present distance monitor may also have multiple display options; for example, one in reverse (see FIG. 5a) for a driver to view in the rear-view mirror and one in normal display (see FIG. 5b) to allow dock workers to see where a vehicle is docking.

In addition, the control logic unit 18 includes means for entering and exiting a sleep mode when necessitated by a vehicles proximity to the loading dock. In accordance with a preferred embodiment of the present invention, the control logic unit 18 is programmed such that when there is no object within some predetermined distance to the sensor 14, for example, 70 inches, the display 20 is turned off. When an object is detected within the selected range, the display 20 is turned on via the control logic unit 18. Additionally, when the vehicle 16, or other object, being sensed has not moved for a certain period of time (for example, 2 minutes) the display 20 is turned off under the control of the control logic unit 18. If the vehicle, or other object, being sensed moves (that is, the control logic unit 18 finds that the present distance does not equal the old distance value), the display 20 is turned back on.

The control logic unit 18 may also be provided with a wireless transmitter 34 for transmitting distance information to a remote display 36, for example, carried within the vehicle 16. Such a feature would allow drivers to view distance and velocity information from multiple locations.

In summary, the control logic unit 18 functions by converting AC power and providing DC power for the display 20, logic system 32 and cable 28. With regard to the processing of distance information received from the sensor 14, the control logic unit 18 ultimately controls the analog to digital converter 25 of the sensor 14, converts the digital distance signal into distance (inches or centimeter), converts the digital distance signal into velocity, drives the display 20 for showing distance and/or velocity data. The control logic unit 18 also provides means for adjusting or calibrating the distance due to differences in mounting and location.

While the preferred embodiments have been shown and described, it will be understood that there is no intent to limit the invention by such disclosure, but rather, is intended to cover all modifications and alternate constructions failing within the spirit and scope of the invention.

1. A distance monitor for a loading dock, comprising:
a sensor monitoring the distance between itself and a vehicle approaching the sensor to generate an analog distance signal representative of the measured distance, the sensor further includes an analog to digital converter that produces a digital distance signal which is transmitted for further processing; and
a control logic unit coupled to the sensor, the control logic unit includes an input for receiving the digital distance signal, a logic system for converting the digital distance signal for presentation and a display for viewing the distance information.

2. The loading dock distance monitor according to claim 1, wherein the sensor includes a microprocessor and the analog to digital converter forms a part of the microprocessor.

3. The loading dock distance monitor according to claim 1, wherein the sensor is an IR sensor.

4. The loading dock distance monitor according to claim 1, wherein the sensor includes power input which is connected to the display for receiving power therefrom.

5. The loading dock distance monitor according the claim 1, wherein the logic system of the control logic unit includes means for converting the digital distance signal into distance information.

6. The loading dock distance monitor according to claim 1, wherein the logic system of the control logic unit includes adjustment means for calibration of the digital distance signal to suit specific mounting conditions for the sensor.

7. The loading dock distance monitor according to claim 1, wherein the control logic unit includes means for entering and exiting a sleep mode when necessitated by vehicle proximity to the loading dock.

8. The loading dock distance monitor according to claim 1, wherein the logic system is a programmable logic device.

9. The loading dock distance monitor according to claim 1, further including a secondary sensor.

10. The loading dock distance monitor according to claim 1, wherein the display presents information in reverse.

11. A loading dock, comprising;
a dock shaped and dimensioned for receipt of a vehicle;
a distance monitor associated with the dock for providing vehicle drivers with distance information as vehicles approach the dock, the distance monitor including:
a sensor mounted adjacent to the dock, the sensor monitoring the distance between itself and a vehicle approaching the sensor to generate an analog distance signal representative of the measured distance, the sensor further includes an analog to digital converter for converting to the analog distance signal generated by the sensor to a digital distance signal which is transmitted for further processing; and
a control logic unit coupled to the sensor, the control logic unit includes an input for receiving the digital distance signal, a logic system for converting the digital distance signal to distance information for presentation and a display for viewing of the distance information.

12. The loading dock according to claim 11, wherein the sensor includes a microprocessor and the analog to digital converter forms a part of the microprocessor.

13. The loading dock according to claim 11, wherein the sensor is an IR sensor.

14. The loading dock according to claim 11, wherein the sensor includes power input which is connected to the display for receiving power therefrom.

15. The loading dock according to claim 11, wherein the logic system of the control logic unit includes means for converting the digital distance signal into distance information.

16. The loading dock according to claim 11, wherein the logic system of the control logic unit includes adjustment means for calibration of the digital distance signal to suit specific mounting conditions for the sensor.

17. The loading dock according to claim 11, wherein the control logic unit includes means for entering and exiting a sleep mode when necessitated by vehicle proximity to the loading dock.

18. The loading dock according to claim 11, wherein the logic system is a programmable logic device.

19. The loading dock according to claim 11, further including a secondary sensor.

20. The loading dock according to claim 11, wherein the display presents information in reverse.
